(19) United States
(12) Patent Application Publication
(10) Pub. No.: US 2020/0305426 A1
(43) Pub. Date: Oct. 1, 2020

(54) BOOSTERS FOR ANTIMICROBIAL, PRESERVATIVE AND BIOCIDAL APPLICATIONS

(71) Applicant: EMERALD KALAMA CHEMICAL, LLC, Vancouver, WA (US)

(72) Inventors: Stephen Finley FOSTER, Ridgefield, WA (US); Kelly Reed PIPPINE, Vancouver, WA (US); Rosanna Williamson STOKES, Charlotte, NC (US)

(21) Appl. No.: 16/760,991

(22) PCT Filed: Nov. 2, 2018
(86) PCT No.: PCT/US2018/058986

§ 371 Date: May 1, 2020

Related U.S. Application Data
(60) Provisional application No. 62/581,335, filed on Nov. 3, 2017.
(60) Provisional application No. 62/583,693, filed on Nov. 9, 2017.

(51) Int. Cl. A01N 37/10; A01N 25/04; A01N 25/30; A01N 31/04

(52) U.S. Cl. CPC A01N 37/10; A01N 31/04; A01N 25/30; A01N 25/04

(57) ABSTRACT

Antimicrobial compounds for use in boosting the efficacy of known antimicrobial, preservative or biocidal compositions. Methods of boosting antimicrobial activity of known compositions, even at low use concentrations, is achieved through adding a booster compound to the known antimicrobial, preservative or biocidal compositions. Use of boosted antimicrobial compositions in end-use applications or products is also described.

### FIELD OF THE INVENTION

The invention is directed to antimicrobial, preservative and biocidal compositions, in particular the use of booster compounds to enhance or boost the antimicrobial efficacy of known antimicrobial, biocidal or preservative compositions. The invention is also directed to boosted or synergistic antimicrobial compositions and their use to reduce, deter, or eliminate microbe loads in a variety of products and applications. Methods for preserving end-use compositions and use applications for the boosted antimicrobial compositions are also a focus of the invention.

### BACKGROUND OF THE INVENTION

Compounds having antimicrobial activity and compositions containing them are well known in the art. Many components of personal care, cosmetic, household products, medical and healthcare products, laundry products, detergents, disinfectants, industrial products, pharmaceutical products, veterinary and consumer products provide viable growth medium for microorganisms. As such, addition of antimicrobial compounds or blends thereof as preservatives to a wide variety of products is highly desirable to prevent, deter, reduce or eliminate growth of microorganisms and maintain the integrity of the products when used over time or in storage.

Ideally, an antimicrobial compound used in a preservative composition has antimicrobial activity against a broad spectrum of organisms, including without limitation Gram positive and negative bacteria, fungi, mold, yeast, protozoa and viruses, and maintains activity over the useful life of the product. Some antimicrobial compounds may be effective alone, while others have low or minimal antimicrobial effect and are used in combination to enhance the biocidal effects of another antimicrobial compound. Efficacy of an antimicrobial for any particular application may vary and ultimately be dependent upon the amount used, the product formulation, the presence of other compounds in the formulation and the type of microorganism typically encountered in the application.

Different products and end use applications warrant use of a variety of different antimicrobial compounds. Selection criteria for antimicrobial compounds used in preservative compositions or any other antimicrobial or biocidal application take into account several factors, including without limitation the type of product, anticipated uses, availability of antimicrobial efficacy data, spectrum of antimicrobial activity, types and amounts of other components in the product, product pH, potential for adverse or toxic effects in use or in production, safety in handling, compatibility problems, interactions with other components, costs, and regulatory requirements or industry standards. As is evident, formulators must evaluate many considerations when antimicrobial compounds, including preservatives, are required or desirable for a product. Predictability of results is difficult. What is effective in one product type may not be effective in another product type.

Amounts of typical antimicrobial compounds utilized to achieve antimicrobial, biocidal or preservative effects also varies. Some compounds are highly effective at low concentrations, while others require a much higher concentration to achieve the same effects. In some applications, addition of other compounds may be required to achieve full antimicrobial effect. In still other applications, use of higher concentrations of certain antimicrobial compounds may be disfavored due to regulatory or other industry requirements, so there may be limits on the amounts used in any given application.

Product pH may also be an important consideration. Some compounds have a narrow pH window for antimicrobial effects. As one example, many personal care products having pH ranges from about pH 5 to pH 9. Many preservative compounds exhibit no or lower antimicrobial activity within this range.

Ideally, antimicrobial compounds selected for use in preservative and other compositions should be environmentally safe and free of toxic effects. Recent scrutiny of the use of preservatives demands that regulatory and other industry standard-setting organization requirements be considered in using preservative compounds, whether used alone or in combination with other preservative compounds. There are environmental and health concerns due to skin and lung irritation as well as potential absorption into the blood and subsequent interference with normal bodily functions. As one example, use of formaldehyde or formaldehyde-donating preservative agents, such as ureas, or formaldehyde-releasing preservatives, such as quaternium compounds or hydantoins, may be prohibited in some countries. Various parabens have reported estrogenic activity and other undesirable effects and are banned in Europe and Japan. Even when considered relatively safe for use in certain applications, some antimicrobial compounds may be used only at specified pre-set amounts.

Safe preservative compounds are known in the art which do not raise health and safety considerations. Unfortunately, many of these safer alternatives, for example, sodium benzoate, benzyl alcohol, 2-phenyl ethanol, and phenoxy ethanol (at low levels) are only able to achieve antimicrobial activity at high concentrations or at a certain pH. Even then, they may not be effective against all microbes, in particular spores, fungi, molds, protozoa, and yeasts.

Combinations of sodium benzoate and benzyl alcohol are general considered safe for a wide variety of applications. Sodium benzoate has limited antimicrobial activity when used alone but is a well-known enhancer of biocidal activity in combination. A disadvantage is that it is not effective over a wide range of pH applications. Sodium benzoate is disclosed for use as an antimicrobial in cosmetics and antiperspirants in amounts ranging from greater than 0.01 to 0.2 wt. %, alone or in combination with other antimicrobials. U.S. Pat. No. 8,784,910 discloses use of sodium benzoate in amounts of 0.01 wt % to 2.0 wt. % in combination with delta gluconolactone as an antimicrobial composition. Sodium benzoate is also disclosed for use alone or in combination with other antimicrobials (including benzyl alcohol) in amounts up to 0.2 wt. % for use in cosmetic foundations, in U.S. Pat. No. 7,201,914. Sodium benzoate is also reported as one component of a liquid concentrate to preserve cosmetics, in combination with phenoxy ethanol and benzyl alcohol (wherein the phenoxy ethanol and benzyl alcohol are present in amounts greater than 25 wt. %). Other uses of sodium benzoate, alone or in combination with other preservative compounds are known in the art.

Like sodium benzoate, benzyl alcohol is an effective antimicrobial used in topically applied products but may require higher concentrations to achieve efficacy. U.S. Pat. Nos. 7,537,776 and 8,501,206 disclose benzyl alcohol in combination with a sorbic acid salt or sodium benzoate and/or phenoxyethanol for use as a preservative concentrate for cosmetics. According to these patents, these active ingredients belong to “soft preservative active ingredients” meaning that they are effective at relatively high use concentrations or may be improved by combination with other more effective active preservative ingredients.

Benzyl alcohol is disclosed as a component of an improved preservative system for topical products, which comprises in addition to benzyl alcohol, edetate disodium (ethylenediaminetetraacetic acid or “EDTA”) and a para-hydrobenzoic acid (paraben), in U.S. Pat. No. 6,120,758. Benzyl alcohol in combination with phenoxy ethanol and phenoxy propanol and glycerol ethers were found to be effective stabilizing compositions for cosmetic products. Benzyl alcohol in typical use concentrations may have a disadvantage due to its smell; it also has weak action against fungi, as does phenoxy propanol and phenoxy ethanol.

Uses of sodium benzoate and benzyl alcohol alone or in combination with each other are effective in some preparations, but their use is generally limited by a narrow spectrum of coverage and/or by pH ranges of products. In addition, while generally considered safe for use, the amounts considered safe may be limited for certain types of products. For example, the Scientific Committee on Consumer Products (adopted Jun. 21, 2005) concludes that sodium benzoate and benzoic acid are safe for use for preservative and non-preservative purposes in maximum concentrations of 2.5 wt. % (cosmetic rinse-off products), 1.7 wt. % (cosmetic oral-care products), and 0.5 wt. % (leave-on products). Benzyl alcohol is safe for all products in amounts up to 1 wt. %. Hence, even if sodium benzoate and benzyl alcohol are effective antimicrobials, the permissible concentrations in some products limit their use across a wide variety of product types and against a broad spectrum of organisms.

Product formulations may contain boosters to enhance antimicrobial performance of known antimicrobial, biocidal or preservative compounds. Sodium benzoate and benzyl alcohol have been used alone or in combination with each other to enhance the efficacy of other antimicrobial compounds. Many of these “boosted” antimicrobial compounds have limited use applications or are the subject of regulatory, environmental and health and safety scrutiny. For example, combinations of sodium benzoate and/or benzyl alcohol, which utilize parabens and phenoxy ethanol and phenoxy propanol, are now disfavored due to regulatory, environmental and health issues, such as irritation and sensitivity of these components when applied topically and other toxic effects.

As such, there remains a need for safer antimicrobial alternatives to use with sodium benzoate and/or benzyl alcohol to improve their antimicrobial effects across a broader spectrum of microbes and pH range. There is also a need for antimicrobial alternatives to boost the known antimicrobial effects of sodium benzoate and/or benzyl alcohol at lower use levels to provide for use across a broader range of product types.

It has been found that certain compounds provide enhanced antimicrobial activity, when used in combination with sodium benzoate and benzyl alcohol, as compared to that achieved by sodium benzoate and benzyl alcohol alone. These compounds facilitate use of sodium benzoate and benzyl alcohol at low use concentrations while enhancing or “boosting” their known antimicrobial effects. These compounds enhance the antimicrobial effects of sodium benzoate and benzyl alcohol across a wider range of pH and against a broader spectrum of Gram positive, Gram negative, yeast and mold organisms. The enhancing or boosting compounds of the invention may have other properties such as hydration and skin conditioning advantages. The inventive boosters also have low or no odor or a pleasant odor profile, which is advantageous with benzyl and other alcohols. Notably, the inventive boosters are generally considered safe at the concentrations discussed herein.

The antimicrobial compositions of the invention are directed to use of 3-phenyl propanol, ethylenediaminetetraacetic acid and salts thereof (“EDTA”), sodium gluconate, glutamic acid N,N-diacetic acid tetrasodium salt (GLDA-Na₄) and caprylyl glycol, alone or preferably in combination with organic acids (and salts thereof) and alcohols. While sodium benzoate and benzyl alcohol are preferred compounds for use with boosters, other organic acids (or salts thereof) and alcohols are within the scope of the invention.

The inventive antimicrobial compositions have applications for use in personal care, cosmetics, toiletries, household products, laundry products, detergents and cleaners. They are also useful antimicrobials for pharmaceutical compositions, healthcare products, medical products, veterinary products, and a variety of industrial products, such as paints, coatings, adhesives, caulks, sealants, inks, and plastisols and other polymeric dispersions and emulsions. The inventive antimicrobial compositions may be provided in low or high concentrations depending on their specific use.

It is an object of the invention to provide antimicrobial compounds and compositions with enhanced performance in preventing, reducing or eliminating the growth of microorganisms in a wide variety of products.

A further object of the invention is to provide preservative compositions for use in a wide variety of products comprising the antimicrobial compounds of the invention and blends thereof.

It is another object of the invention to provide boosted antimicrobial, preservative or biocidal compositions for a variety of end uses to prevent, reduce, or eliminate growth of microorganisms during useful life or storage of a product.

Yet another object of the invention is to provide antimicrobial compositions that are considered environmentally safe, free of adverse or toxic effects, and effective at low concentrations.

Another object of the invention is to provide a method for boosting the antimicrobial performance of other known antimicrobial compounds.

Still another object of the invention is to provide of variety of end-use products or applications comprising the boosted antimicrobial or preservative compositions.

Other objects of the invention will be evident to one skilled in the art.

### SUMMARY OF THE INVENTION

The invention is directed compositions for use in a variety of end uses and products, having enhanced or boosted activity against a broad spectrum of Gram positive and Gram negative bacteria, fungi, mold, yeast, protozoa and viruses, among others, across a range of pH, in an end use application. In particular, the invention is directed to enhanced antimicrobial compositions comprising an organic acid (or salt thereof), an alcohol that is not a booster compound, and a booster compound.

The invention is also directed to methods of boosting the efficacy of an antimicrobial composition comprising an organic acid (or salt thereof) and/or an alcohol, comprising the step of adding a booster compound to the antimicrobial composition, wherein the booster compound comprises 3-phenyl propanol, benzylamine, ethylenediamine tetraacetic acid or sodium salt thereof (EDTA), sodium gluconate, glutamic acid N,N-diacetic acid tetrasodium salt (GLDA-Na₄), or caprylyl glycol.

The invention is also directed to end use compositions comprising the enhanced or boosted antimicrobial compositions of the invention.

An advantage of the inventive antimicrobial compositions is that they are environmentally safe and have few health and safety concerns or regulatory limits. The invention is useful to boost antimicrobial efficacy of known antimicrobial compounds, which may be limited by permissible or allowed concentrations and or pH conditions associated with their use.

The boosted antimicrobial compositions of the invention are utilized in end use products in amounts sufficient to achieve at least a two-day or fourteen-day, two-log reduction of at least two organisms selected from the group consisting of Pseudomonas aeruginosa, Staphylococcus aureus, Aspergillus brasiliensis, Candida albicans, and Escherichia coli as more fully described herein.

In one embodiment, the invention is directed to a composition having enhanced or boosted antimicrobial activity against a wide range of microorganisms comprising an organic acid or salt thereof and/or an alcohol in combination with a booster compound that is a chelating agent, an alcohol, an amine or a glycol, or mixtures thereof.

In a second embodiment, the invention is directed to an enhanced or boosted antimicrobial composition comprising sodium benzoate and benzyl alcohol and a booster compound that is ethylenediaminetetraacetic acid or sodium salt thereof (EDTA), sodium gluconate, glutamic acid N,N-diacetic acid tetrasodium salt (GLDA-Na₄), 3-phenyl propanol, benzylamine, or caprylyl glycol, or mixtures thereof.

In another embodiment, the invention is directed to an enhanced or boosted antimicrobial composition, wherein the amounts of the composition utilized in an end use composition are sufficient to achieve a two-day or 14-day, two-log reduction of at least two organisms selected from the group consisting of Pseudomonas aeruginosa, Staphylococcus aureus, Aspergillus brasiliensis, Candida albicans, and Escherichia coli according to the methods described herein.

In yet another embodiment, the invention is directed to a method of enhancing or boosting the efficacy of known antimicrobial compounds or compositions by adding a sufficient amount of a boosting compound to increase antimicrobial efficacy of the antimicrobial compound or composition.

In still another embodiment, the invention is directed to a method of boosting the antimicrobial efficacy of an antimicrobial composition comprising an organic acid (or salt thereof) and/or an alcohol, by adding a booster compound to the antimicrobial composition.

Another embodiment of the invention is directed to a concentrated antimicrobial blend, consisting only of booster compounds, organic acids (or salts thereof) and alcohols, which may be added to end use products during manufacture or preparation and/or further diluted to a concentration level sufficient to achieve antimicrobial efficacy in an end use product or application.

Still another embodiment of the invention are end use compositions containing the enhanced or boosted antimicrobial compositions of the invention including without limitation household products, laundry products, health care products, medical products, disinfectants, cosmetics, personal care products, pharmaceuticals, veterinary products, industrial products, paints, coatings, inks, lacquers, adhesives, sealants, caulks, plastisols, polymeric dispersions, polymeric emulsions, or oil and gas recovery and drilling corn positions.

Other embodiments of the invention are the use of booster compounds in combination with a variety of traditional preservatives specific to end use application to improve antimicrobial efficacy of the traditional preservatives and/or reduce the amount of traditional preservatives needed to achieve antimicrobial effect.

Particularly preferred end use embodiments of the invention are a skin lotion, waterborne coating or hair conditioning shampoo comprising the enhanced antimicrobial compositions of the invention, although the end uses are not limited as such.

Other embodiments and uses for the inventive compositions will be evident to one skilled in the art based on the disclosure herein.

### BRIEF DESCRIPTION OF THE DRAWINGS

FIG. 1 reflects log reduction data for colony forming units (CFU) of microbe strains exposed to various concentrations of EDTA in tryptic soy broth growth media at pH 6.5 after 30 minutes, with each formulation having a fixed concentration of 0.25 wt. % sodium benzoate and 0.25 wt. % benzyl alcohol.

FIG. 2 reflects log reduction data of colony forming units (CFU) of microbe strains exposed to EDTA concentrations in tryptic soy broth growth media at pH 6.5 after two days. Each formulation had a fixed concentration of 0.25 wt. % of sodium benzoate and 0.25 wt. % of benzyl alcohol.

FIG. 3 reflects log reduction data of colony forming units (CFU) of microbe strains exposed to EDTA concentrations in tryptic soy broth growth media at pH 6.5 after fourteen days. Each formulation had a fixed concentration of 0.25 wt. % of sodium benzoate and 0.25 wt. % of benzyl alcohol.

FIG. 4 reflects log reduction data of colony forming units (CFU) of microbe strains exposed to EDTA concentrations in tryptic soy broth growth media at pH 6.5 after twenty-eight days. Each formulation had a fixed concentration of 0.25 wt. % of sodium benzoate and 0.25 wt. % of benzyl alcohol.

FIG. 5 reflects log reduction data of colony forming units (CFU) of microbe strains exposed to sodium gluconate concentrations in tryptic soy broth growth media at pH 6.5 after 30 minutes. Each formulation had a fixed concentration of 0.25 wt. % of sodium benzoate and 0.25 wt. % of benzyl alcohol.

FIG. 6 reflects log reduction data of colony forming units (CFU) of microbe strains exposed to sodium gluconate concentrations in tryptic soy broth growth media at pH 6.5 after two days. Each formulation had a fixed concentration of 0.25 wt. % of sodium benzoate and 0.25 wt % of benzyl alcohol.

FIG. 7 reflects log reduction data of colony forming units (CFU) of microbe strains exposed to sodium gluconate concentrations in tryptic soy broth growth media at pH 6.5 after fourteen days. Each formulation had a fixed concentration of 0.25 wt. % of sodium benzoate and 0.25 wt. % of benzyl alcohol.

FIG. 8 reflects log reduction data of colony forming units (CFU) of microbe strains exposed to sodium gluconate concentrations in tryptic soy broth growth media at pH 6.5 after twenty-eight days. Each formulation had a fixed concentration of 0.25 wt. % of sodium benzoate and 0.25 wt. % of benzyl alcohol.

FIG. 9 reflects log reduction data of colony forming units (CFU) of microbe strains exposed to caprylyl glycol concentrations in tryptic soy broth growth media at pH 6.5 after 30 minutes. Each formulation had a fixed concentration of 0.25 wt. % of sodium benzoate and 0.25 wt. % of benzyl alcohol.

FIG. 10 reflects log reduction data of colony forming units (CFU) of microbe strains exposed to caprylyl glycol concentrations in tryptic soy broth growth media at pH 6.5 after two days. Each formulation had a fixed concentration of 0.25 wt. % of sodium benzoate and 0.25 wt. % of benzyl alcohol.

FIG. 11 reflects log reduction data of colony forming units (CFU) of microbe strains exposed to EDTA concentrations in tryptic soy broth growth media at pH 8 after 30 minutes. Each formulation had a fixed concentration of 0.25 wt. % of sodium benzoate and 0.25 wt. % of benzyl alcohol.

FIG. 12 reflects log reduction data of colony forming units (CFU) of microbe strains exposed to EDTA concentrations in tryptic soy broth growth media at pH 8 after two days. Each formulation had a fixed concentration of 0.25 wt. % of sodium benzoate and 0.25 wt. % of benzyl alcohol.

FIG. 13 reflects log reduction data of colony forming units (CFU) of microbe strains exposed to EDTA concentrations in tryptic soy broth growth media at pH 8 after fourteen days. Each formulation had a fixed concentration of 0.25 wt. % of sodium benzoate and 0.25 wt. % of benzyl alcohol.

FIG. 14 reflects log reduction data of colony forming units (CFU) of microbe strains exposed to EDTA concentrations in tryptic soy broth growth media at pH 8 after twenty-eight days. Each formulation had a fixed concentration of 0.25 wt. % of sodium benzoate and 0.25 wt. % of benzyl alcohol.

FIG. 15 reflects log reduction data of colony forming units (CFU) of microbe strains exposed to sodium gluconate concentrations in tryptic soy broth growth media at pH 8 after 30 minutes. Each formulation had a fixed concentration of 0.25 wt. % of sodium benzoate and 0.25 wt. % of benzyl alcohol.

FIG. 16 reflects log reduction data of colony forming units (CFU) of microbe strains exposed to sodium gluconate concentrations in tryptic soy broth growth media at pH 8 after two days. Each formulation had a fixed concentration of 0.25 wt. % of sodium benzoate and 0.25 wt. % of benzyl alcohol.

FIG. 17 reflects log reduction data of colony forming units (CFU) of microbe strains exposed to sodium gluconate concentrations in tryptic soy broth growth media at pH 8 after fourteen days. Each formulation had a fixed concentration of 0.25 wt. % of sodium benzoate and 0.25 wt. % of benzyl alcohol.

FIG. 18 reflects log reduction data of colony forming units (CFU) of microbe strains exposed to sodium gluconate concentrations in tryptic soy broth growth media at pH 8 after twenty-eight days. Each formulation had a fixed concentration of 0.25 wt. % of sodium benzoate and 0.25 wt. % of benzyl alcohol.

FIG. 19 reflects log reduction data of colony forming units (CFU) of microbe strains exposed to caprylyl glycol concentrations in tryptic soy broth growth media at pH 8 after 30 minutes. Each formulation had a fixed concentration of 0.25 wt. % of sodium benzoate and 0.25 wt. % of benzyl alcohol.

FIG. 20 reflects log reduction data of colony forming units (CFU) of microbe strains exposed to caprylyl glycol concentrations in tryptic soy broth growth media at pH 8 after two days. Each formulation had a fixed concentration of 0.25 wt. % of sodium benzoate and 0.25 wt. % of benzyl alcohol.

FIG. 21 reflects log reduction data of colony forming units (CFU) of microbe strains exposed to 3-phenyl propanol concentrations in skin lotion media at pH 6.5 after two days. Each formulation had a fixed concentration of 0.25 wt. % of sodium benzoate and 0.25 wt. % of benzyl alcohol.

FIG. 22 reflects log reduction data of colony forming units (CFU) of microbe strains exposed to 3-phenyl propanol concentrations in skin lotion media at pH 6.5 after 14 days. Each formulation had a fixed concentration of 0.25 wt. % of sodium benzoate and 0.25 wt. % of benzyl alcohol.

FIG. 23 reflects log reduction data of colony forming units (CFU) of microbe strains exposed to sodium benzoate, benzyl alcohol, and EDTA concentrations in skin lotion media at pH 6.5 after two days. Each formulation had a fixed concentration of 0.5 wt. % of sodium benzoate and 0.25 wt. % of EDTA, with varying concentrations of benzyl alcohol. Control is comprised of 0.5 wt. % sodium benzoate and 1 wt. % benzyl alcohol without EDTA.

FIG. 24 reflects log reduction data of colony forming units (CFU) of microbe strains exposed to sodium benzoate, benzyl alcohol, and EDTA concentrations in skin lotion media at pH 6.5 after 14 days. Each formulation had a fixed concentration of 0.5 wt. % of sodium benzoate and 0.25 wt. % of EDTA with varying concentrations of benzyl alcohol. Control is comprised of 0.5 wt. % sodium benzoate and 1 wt. % benzyl alcohol without EDTA.

FIG. 25 reflects log reduction data of colony forming units (CFU) of microbe strains exposed to sodium benzoate, benzyl alcohol, and sodium gluconate concentrations in skin lotion media at pH 6.5 after two days. Each formulation had a fixed concentration 0.5 wt. % of sodium benzoate and 0.25 wt. % of sodium gluconate with varying concentrations of benzyl alcohol. Control is comprised of 0.5 wt. % sodium benzoate and 1 wt. % benzyl alcohol without sodium gluconate.

FIG. 26 reflects log reduction data of colony forming units (CFU) of microbe strains exposed to sodium benzoate, benzyl alcohol, and sodium gluconate concentrations in skin lotion media at pH 6.5 after 14 days. Each formulation had a fixed concentration 0.5 wt. % of sodium benzoate and 0.25 wt. % of sodium gluconate, with varying concentrations of benzyl alcohol. Control is comprised of 0.5 wt. % sodium benzoate and 1 wt. % benzyl alcohol without sodium gluconate.

FIG. 27 reflects log reduction data of colony forming units (CFU) of microbe strains exposed to sodium benzoate, benzyl alcohol, and caprylyl glycol concentrations in skin lotion media at pH 6.5 after two days. Each formulation had a fixed concentration 0.25 wt. % of sodium benzoate and 0.25 wt. % benzyl alcohol, with varying concentrations of caprylyl glycol. Control is comprised of 0.5 wt. % sodium benzoate and 1 wt. % benzyl alcohol without caprylyl glycol.

FIG. 28 reflects log reduction data of colony forming units (CFU) of microbe strains exposed to sodium benzoate, benzyl alcohol, and caprylyl glycol concentrations in skin lotion media at pH 6.5 after 14 days. Each formulation had a fixed concentration 0.25 wt. % of sodium benzoate and 0.25 wt % benzyl alcohol, with varying concentrations of caprylyl glycol. Control is comprised of 0.5 wt. % sodium benzoate and 1 wt. % benzyl alcohol without caprylyl glycol.

FIG. 29 reflects log reduction data for colony forming units (CFU) of microbe strains in tryptic soy broth growth media at pH 9.0 up to 28 days.

FIG. 30 reflects log reduction data for colony forming units (CFU) of microbe strains exposed to benzylamine at 2.5 wt. % in tryptic soy broth at pH 9.0 up to one week.

### DETAILED DESCRIPTION OF THE INVENTION

The invention is directed to compositions having improved antimicrobial, biocidal or preservative efficacy against a wide range of microorganisms as described herein. In particular, the invention is directed to use of a booster compound in combination with known antimicrobial, preservative or biocidal compounds to achieve improved antimicrobial, preservative, or biocidal efficacy over that achieved without use of the booster compounds.

The invention is also directed to methods for enhancing the antimicrobial or preservative performance of known antimicrobial, preservative or biocidal compounds by adding a booster compound to the compounds. In particular, the invention is directed to methods for enhancing the antimicrobial or preservative efficacy of organic acids (or salts thereof) or alcohols, or mixtures thereof. In a preferred embodiment, the invention is directed to enhancing the antimicrobial activity of sodium benzoate- and benzyl alcohol-containing compositions to improve antimicrobial performance, although the invention is not limited to sodium benzoate and benzyl alcohol compositions. Antimicrobial activity of other organic acids (or salts thereof) and/or alcohols described herein may also be boosted by use of the compounds and methods of the invention.

Finally, the invention is directed to end use applications, products and compositions comprising the enhanced antimicrobial compositions of the invention.

For purposes of this invention, the terms “microorganisms”, “microbiological organisms”, and “microbes” shall mean and include bacteria, fungi, yeast, molds, protozoa, and viruses and are used interchangeably herein. The invention is directed to use of antimicrobial compositions against a wide variety of microorganisms including without limitation Gram positive bacteria, Gram negative bacteria, fungi, mold, yeast, protozoa and viruses.

“Antimicrobial” and “biocidal” shall mean and include the ability of the inventive antimicrobial compositions to prevent, reduce, deter, eliminate or render harmless, any harmful microorganism by chemical means and are used interchangeably herein. “Preservative” may also be used to describe the antimicrobial and biocidal effects of the inventive compositions, or an end use application for the antimicrobial compositions of the invention.

“Activity”, “efficacy”, “effectiveness” or “performance”, with respect to antimicrobials, refer to the antimicrobial functions of the inventive compositions that are improved through the use of booster compounds of the invention.

Concentrations of components are expressed in weight percent (wt. %), and the weight percent is based upon the total weight of an end use product unless otherwise stated.

The terms “enhancer”, “booster”, “enhanced”, “boosted”, “enhancing” or “boosting”, in context, are used interchangeably herein to refer to the synergistic and improved antimicrobial effects or preservation achieved through the use of compounds that, unexpectedly, increase or improve antimicrobial efficacy of known antimicrobial compounds in an end use composition.

The unexpected results of the invention are achieved by adding sufficient amounts of certain compounds that may themselves have some slight or low antimicrobial activity to boost the antimicrobial or preservative activity of organic acids (or salts thereof) and alcohols traditionally used as antimicrobials, biocides or preservatives, such as sodium benzoate and benzyl alcohol, to achieve improved antimicrobial or preservative activity not achieved with the use of organic acids (or salts thereof) or alcohols alone or in combination. The invention takes advantage of the unexpected synergism of booster compounds and known antimicrobial compounds, in combination, to achieve an antimicrobial composition that exhibits improved antimicrobial or preservative efficacy and is considered environmentally safe, free of adverse and toxic effects and effective at low use levels. The inventive compositions should also withstand scrutiny of regulatory and industry standard-setting agencies.

Suitable booster compounds for use in the invention include a chelating agent such as EDTA, sodium gluconate, glutamic acid, N,N-diacetic acid tetrasodium salt (GLDA-Na₄), an alcohol such as 3-phenyl propanol, a glycol such as caprylyl glycol, or an amine such as benzylamine, or mixtures thereof.

The booster compounds of the invention are preferably used in combination with sodium benzoate and benzyl alcohol, although the invention is not limited as such, Other organic acids (and salts thereof), other alcohols or other preservatives traditionally used in certain end use applications, which are known to have antimicrobial activity, may also be useful in combination with the booster compounds of the invention.

Exemplary organic acids and salts thereof including without limitation: benzoic acid, sorbic acid, citric acid, propionic acid, lactic acid, fumaric acid, sodium benzoate, potassium benzoate, sodium citrate, potassium sorbate, sodium sorbate, or sodium lactate, or mixtures thereof. Exemplary non-booster alcohols include without limitation ethanol, propanol, benzyl alcohol, 2,4 dichlorobenzyl alcohol, benzyl ethanol, phenyl ethanol or phenoxyethanol, or mixtures thereof.

The booster compounds of the invention may also be used in combination with traditional preservatives specific to certain end use applications, which are not organic acids or salts thereof or alcohols, to improve antimicrobial efficacy of the traditional preservatives or reduce the amounts of traditional preservatives required.

Amounts of booster compounds useful in the inventive compositions vary according to the compound utilized. By way of non-limiting example, amounts of 3-phenyl propanol range from 0.005 wt. % to 1.99 wt. %. Amounts of EDTA range from 0.005 wt. % to 5 wt. %. Amounts of sodium gluconate range from 0.005 wt. % to 5 wt. %. Amounts of GLDA-Na₄ range from 0.005 wt. % to 5 wt. %. Amounts of caprylyl glycol useful in the inventive compositions range from 0.005 wt. % to 5 wt. %. Amounts of benzylamine range from 0.005 wt. % to 5 wt. %. If mixtures of the booster compounds of the invention are utilized, the total amount utilized ranges from 0.005 wt. % to 5 wt. %. Depending on the particular use application, one skilled in the art would be able to determine suitable amounts of useful boosters.

Amounts of sodium benzoate suitable for use in the inventive compositions range from 0.005 wt. % to 10 wt. %, and amounts of benzyl alcohol range from 0.005 wt. % to 10 wt. %. Useful amounts of other organic acids (and salts thereof) and other alcohols also fall within these ranges.

Suitable amounts of each compound may vary within the stated range depending upon end use applications, concentration and type of other components, compatibilities, interactions, pH of the final product, and regulatory and industry standard considerations, as one skilled in the art would understand.

The antimicrobial compositions of the invention may also be provided in concentrated form for ease of handling and costs. Concentrated forms are particularly useful in the manufacturing process. Concentrated blends of the antimicrobial components are within the scope of the invention. Generally, a concentrated antimicrobial blend of the invention is prepared by adding the booster compound in amounts ranging from about 0.01 wt. % to 90 wt. %, to a combination of an organic acid or salt thereof and an alcohol, wherein the organic acid or salt thereof and alcohol are added in amounts sufficient so that the amounts of all of the components of the concentrated antimicrobial blend total 100 wt. %, as based on the total weight of the components of the concentrated antimicrobial blend.

One non-limiting example includes 3-phenyl propanol in amounts ranging from 30.2 wt. % to 99.5 wt. %, alone or in combination with an organic acid (or its salt) and an alcohol. A particularly preferred embodiment for 3-phenyl propanol is an antimicrobial blend comprising 41 wt. % of 3-phenyl propanol, 29.5 wt. % sodium benzoate, and 29.5 wt. % benzyl alcohol.

Non-limiting examples of solvents that may be used to dilute the concentrated antimicrobial compositions of the invention include without limitation water, ethanol, propanol, isopropyl alcohol, propylene glycol, dipropylene glycol, diethylene glycol dibenzoate, dipropylene glycol dibenzoate, propylene glycol dibenzoate, 3-phenyl propyl benzoate, acetone, ethyl acetate, n-butyl acetate, propylene glycol n-butyl ether, dipropylene glycol n-butyl ether, diethylene glycol monomethyl ether, diethylene glycol monoethyl ether, dipropylene glycol dimethyl ether, xylene, toluene, tetrahydrofuran, chloroform, methyl ethyl ketone, cyclohexane or mixtures thereof. Other solvents suitable for use with the inventive antimicrobial compositions or in the particular end use applications utilizing them will be known to one skilled in the art.

The inventive antimicrobial compositions are described with respect to efficacy in tryptic soy broth, which is an excellent surrogate for evaluating antimicrobial efficacy in water-based or aqueous applications. End use applications for the inventive antimicrobial compositions are described with respect to use in skin lotion formulations, waterborne coatings, and hair conditioning and shampoo applications; however, the end uses are not intended to be limited as such. Non-limiting end-use applications for the inventive antimicrobial compositions include household products, laundry products, detergents, cleaners, cosmetics, toiletries, personal care compositions, disinfectants, healthcare products, medical products, veterinary products, pharmaceuticals, and consumer products. Non-limiting examples of industrial end-use applications include paint, coatings, lacquers, inks, adhesives, caulks, sealants, plastisols and other polymeric dispersions and emulsions, and compositions for use in oil and gas recovery and drilling processes. The inventive compositions are especially useful for aqueous based formulations, both water soluble or using water as a carrier. Still other end-use applications will be evident to one skilled in the art.

While the boosted antimicrobial compositions of the invention are useful in a variety of end-use products and applications, end-use products and applications comprising the boosted compositions are within the scope of the invention.

The invention is illustrated by the examples set forth below, which are not intended to be limiting.

### EXAMPLES

Methodology and Materials

Challenge Testing Methodology—Experimental—Several industry standard testing methodologies exist for evaluating antimicrobial efficacy. Two common examples of such standards include United States Pharmacopeia (USP 51) and European Pharmacopeia (EP) testing methodology. These methodologies are particularly useful in that they have criteria and methodologies distinguishing between oral products, topical products and pharmaceutical products, among others.

In conducting the testing, the compound or product to be evaluated is separated out into individual containers, each being challenged with one of the method-specified microorganisms (S. aureus—ATCC 6538 USP51/EP, E. coli—ATCC 8739 EP, P. aeruginosa—ATCC 9027 USP51/EP, C. albicans—ATCC 10231 USP51/EP, and A. brasiliensis—ATCC 16404 USP51/EP) at a concentration of >1×10⁵ CFU/g or ml. The initial concentration of each microorganism is determined by inoculating a control substance and using standard dilution and plating techniques. At the time of test initiation, a separate volume, typically 1 ml or 1 g, of the compound or product to be evaluated is diluted in a volume of chemical neutralizer broth, i.e., inoculated, to be used in the neutralization and recovery validation. The inoculated broth is held at room temperature and is evaluated at specific intervals. USP-51 evaluates at the 14-day and 28-day intervals. EP evaluates results at 2-day, 7-day, 14-day, and 28-day. At each contact time, the inoculated product is chemically neutralized and plated using standard dilution and plating techniques. After a period of incubation (48 hours for bacteria, up to 5 days for yeast and mold) surviving microorganisms are counted, and the log reduction of each microorganism at each interval is reported.

For the European Pharmacopeia, a “pass” test for efficacy is a two-log reduction for bacteria after two days, a three-log reduction in bacteria after three days, a two-log reduction in mold and yeast at 14 days and no increase at 28 days. For the USP-51, a two-log reduction in bacteria is required at 14 days and no increase at 28 days. For mold and yeast, USP-51 requires no increase at 14 days and 28 days. “No increase” is defined as a 0.5 log reduction.

Tryptic soy broth, commonly referred to as soybean-casein digest medium or tryptic soy broth, is used as a growth medium to cultivate a wide variety of microorganisms. Tryptic soy broth is an exceptionally difficult environment to preserve as it is an ideal growth medium for microbes with optimized levels of water and nutrients. As such, it is an exceptional test medium for evaluating antimicrobial efficacy and serves as a useful surrogate particularly for waterborne applications. The general tryptic soy broth formula (per liter) is listed in the table below.

| Formula per Liter | |
|---|---|
| Casein Digest Peptone | 17.0 g |
| Papaic Digest of Soybean Meal | 3.0 g |
| Dipotassium Phosphate | 2.5 g |
| Sodium Chloride | 5.0 g |
| Dextrose | 2.5 g |

Skin Lotion Formulation Experimental—An exemplary, model skin lotion having a pH of 6.5 as set forth below in Table 1 was prepared for testing. The invention is not limited to use in this specific lotion but was used to illustrate the advantages of the invention.

TABLE 1
Skin Lotion Formulation

| INCI Name | Wt. % | Function |
|---|---|---|
| Stage A | | |
| Water | Varies | Carrier |
| Glycerin | 5.0% | Humectant |
| Xantham Gum | 0.1% | Rheology Modifier |
| Chelators or Glycols | Varies | |
| Stage B | | |
| Cetearyl Alcohol | 3.0% | Rheology Modifier |
| Steareth-21 | 2.0% | Emulsifier |
| Steareth-2 | 2.0% | Emulsifier |
| Mineral Oil | 5.0% | Emollient |
| Petrolatum | 2.0% | Emollient |
| Stage C | | |
| Sodium Benzoate | Varies | Preservative |
| Benzyl Alcohol | Varies | Preservative |
| 3-Phenyl propanol | Varies | Antimicrobial |

The challenge testing was conducted by a Food and Drug Administration (FDA) certified outside testing lab utilizing standard USP-51 and European Pharmacopeia methodologies as summarized in the Challenge Testing Methodology section above. Antimicrobial efficacy was determined in tryptic soy broth growth media, pH-balanced with sodium hydroxide or hydrochloric acid as required to achieve specific pH ranges. Use applications involve products having a variety of pH conditions. As such, efforts were made to assess efficacy over a typical range of pH conditions.

### Example 1—Tryptic Soy Broth Studies, pH 6.5, EDTA

The boosting efficacy of various concentrations of EDTA (0 to 0.5 wt. %, with “0” being a control without the EDTA booster) in tryptic soy broth growth media at pH 6.5 was evaluated against various microbes (A. brasiliensis, C. albicans, E. coli, P. aeruginosa, and S. aureus). Each soy broth formulation contained a fixed amount of 0.25 wt. % sodium benzoate and 0.25 wt. % benzyl alcohol.

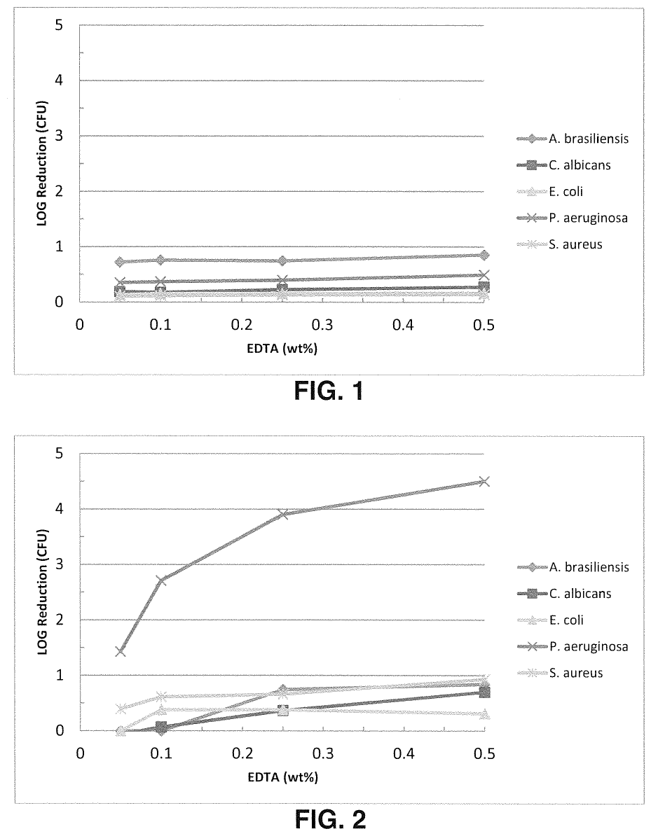

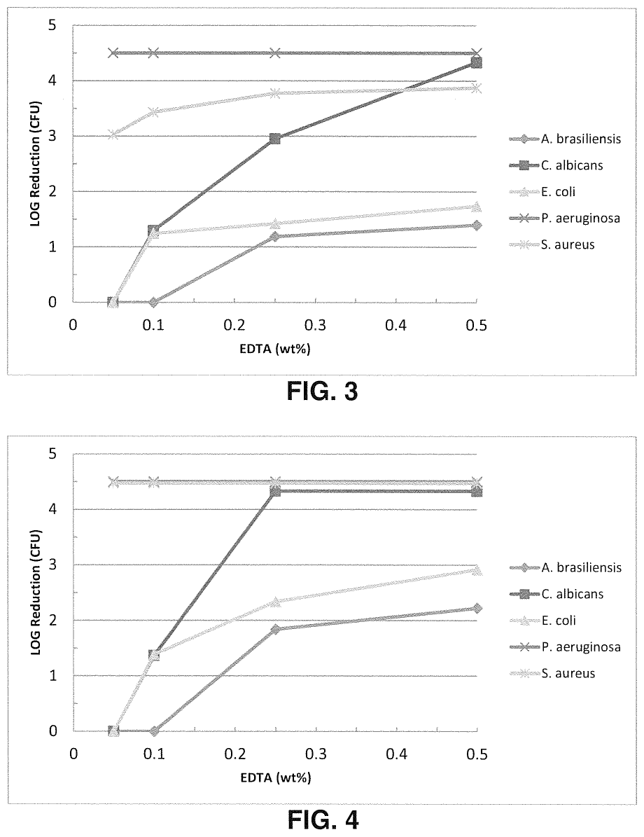

The data reflected in FIGS. 1 through 4 shows the improved antimicrobial performance achieved by the addition of EDTA at 30 minutes, two days, fourteen days and twenty-eight days.

The data demonstrated antimicrobial boosting potential of EDTA in aqueous applications utilizing sodium benzoate and benzyl alcohol. The data also demonstrated that EDTA is effective at boosting antimicrobial activity of an organic acid salt (sodium benzoate) and an alcohol (benzyl alcohol) at low use concentrations, with particularly good activity against Pseudomonas aeruginosa at two-days.

### Example 2—Tryptic Soy Broth Studies, pH 6.5, Sodium Gluconate

Studies were conducted in the same manner and against the same microbes as Example 1 to evaluate the boosting efficacy of various concentrations of sodium gluconate (0 to 0.5 wt %, with “0” being a control without sodium gluconate) in tryptic soy broth comprising 0.25 wt. % sodium benzoate and 0.25 wt. % benzyl alcohol. Data was reported at 30 minutes, two days, fourteen days and twenty-eight days.

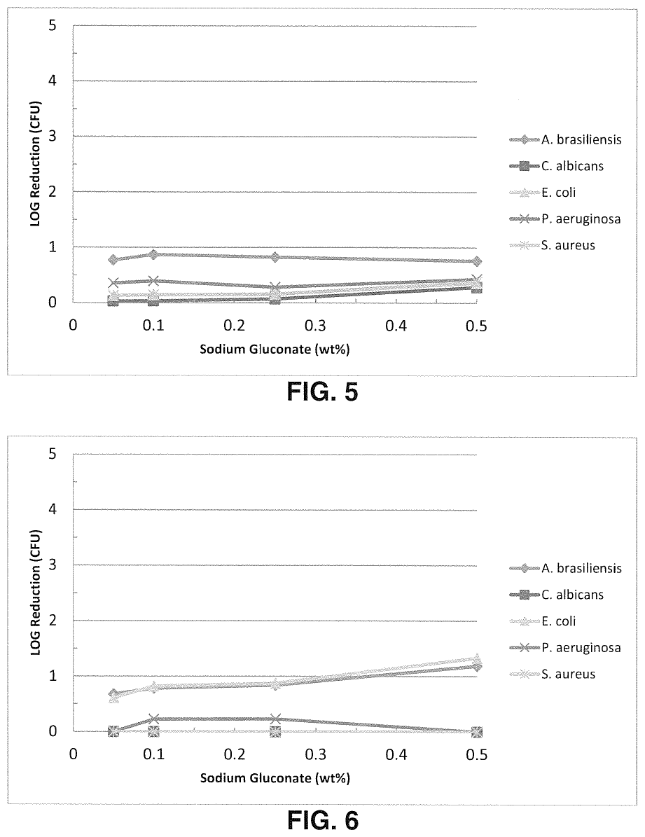

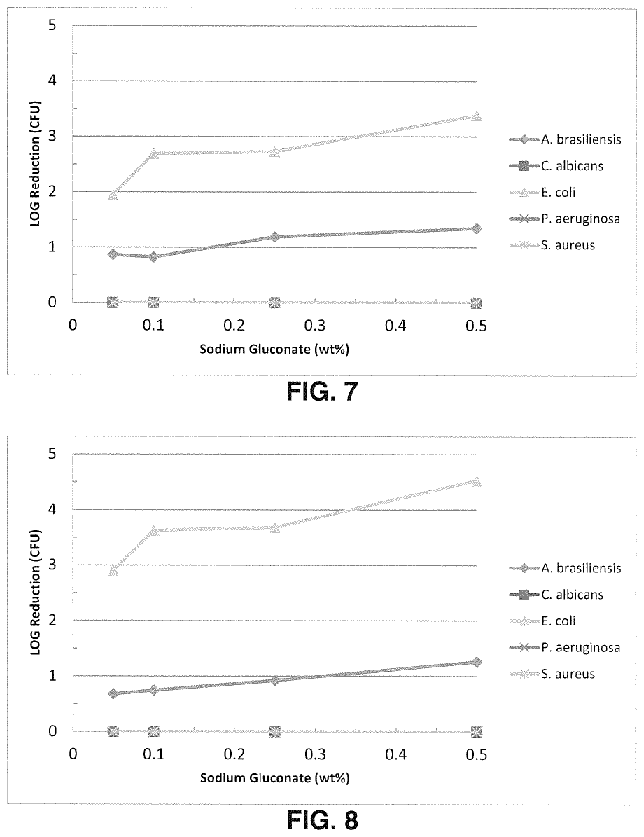

FIGS. 5 through 8 show the boosting performance of sodium gluconate at pH 6.5. Good activity was seen against the mold A. brasiliensis at 14 and 28 days.

The data demonstrated the antimicrobial boosting potential of sodium gluconate in combination with sodium benzoate and benzyl alcohol in aqueous applications, showing increased log reduction with increased concentration of sodium gluconate. While not as strong a booster as EDTA in this media and with the sodium benzoate/benzyl alcohol combination, the increase in log reduction was seen at 14 days and 28 days in the tryptic soy broth studies, which is a particularly appropriate surrogate for waterborne or aqueous applications.

### Example 3—Tryptic Soy Broth Studies, pH 6.5, Caprylyl Glycol

Studies were conducted in the same manner and against the same microbes as Example 1 to evaluate the boosting efficacy of various concentrations of caprylyl glycol (0 to 5 wt. %, with “0” being a control without caprylyl glycol) in tryptic soy broth comprising 0.25 wt. % sodium benzoate and 0.25 wt. % benzyl alcohol. Data was reported at 30 minutes and two days.

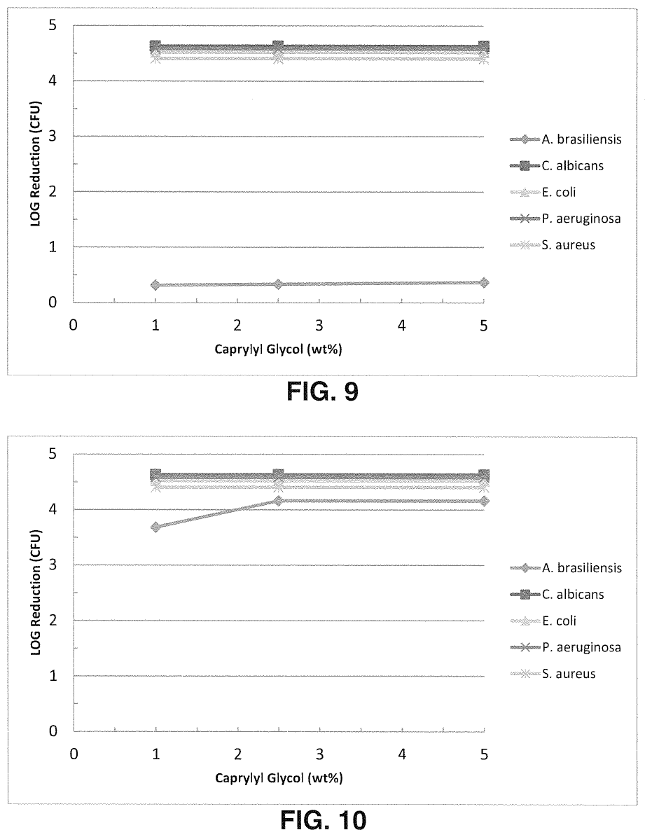

FIGS. 9 and 10 show the performance of caprylyl glycol and reflect a two-day, two-log reduction achieved against all microbes tested regardless of concentration of caprylyl glycol.

The data demonstrated outstanding antimicrobial boosting potential for caprylyl glycol at the lowest use concentration (1 wt. %). Caprylyl glycol has a known added advantage in certain applications of functioning as a skin conditioning agent, making it very useful for cosmetic and personal care product preservation.

### Example 4—Tryptic Soy Broth Studies, pH 8, EDTA

The boosting efficacy of various concentrations of EDTA (0 to 0.5 wt. % as in Example 1) in tryptic soy broth growth media at pH 8 was evaluated against the same microbes as utilized in Example 1. Each soy broth formulation contained a fixed amount of 0.25 wt. % sodium benzoate and 0.25 wt % benzyl alcohol.

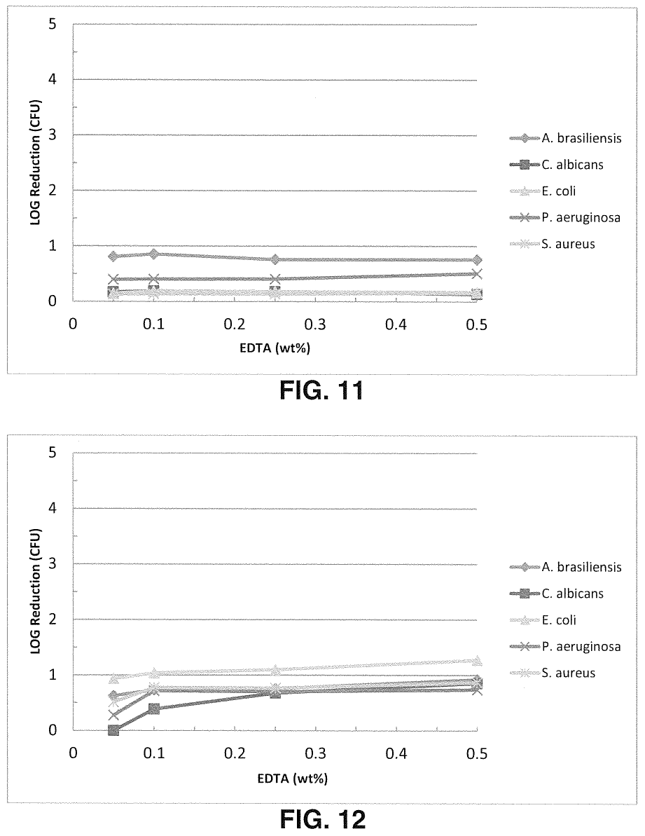

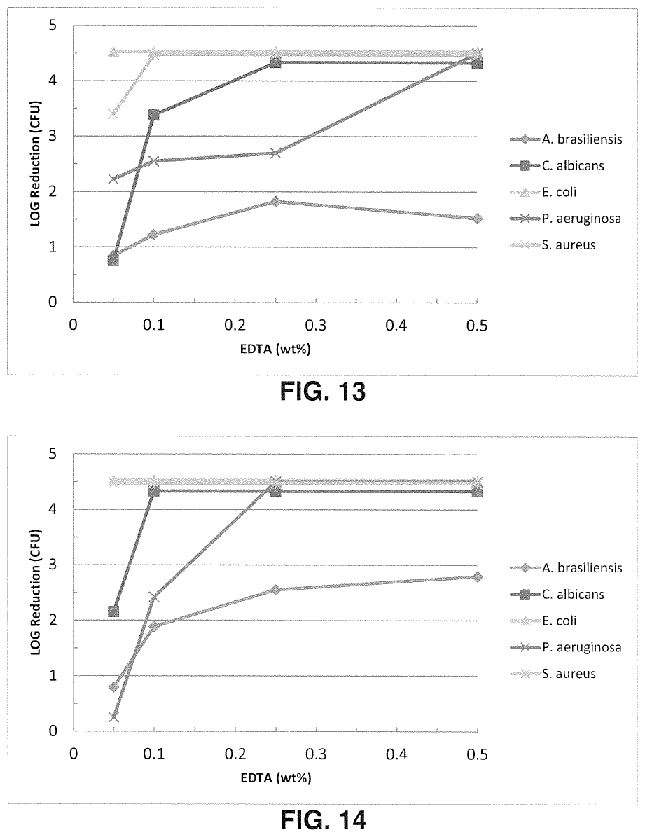

The data reflected in FIGS. 11 through 14 shows the improved antimicrobial performance achieved by the combination of sodium benzoate, benzyl alcohol and EDTA at 30 minutes, two days, fourteen days and twenty-eight days, respectively. The data demonstrated antimicrobial boosting potential of EDTA in aqueous applications showing increased log reduction with increasing concentrations at pH 8.0.

### Example 5—Tryptic Soy Broth Studies, pH 8, Sodium Gluconate

The antimicrobial performance of various concentrations (0-0.5 wt. % as in Example 2) of sodium gluconate in tryptic soy broth growth media at pH 8 was evaluated in combination with sodium benzoate and benzyl alcohol present in the same concentrations as in Example 4. The data was collected at 30 minutes, two days, fourteen days and twenty-eight days.

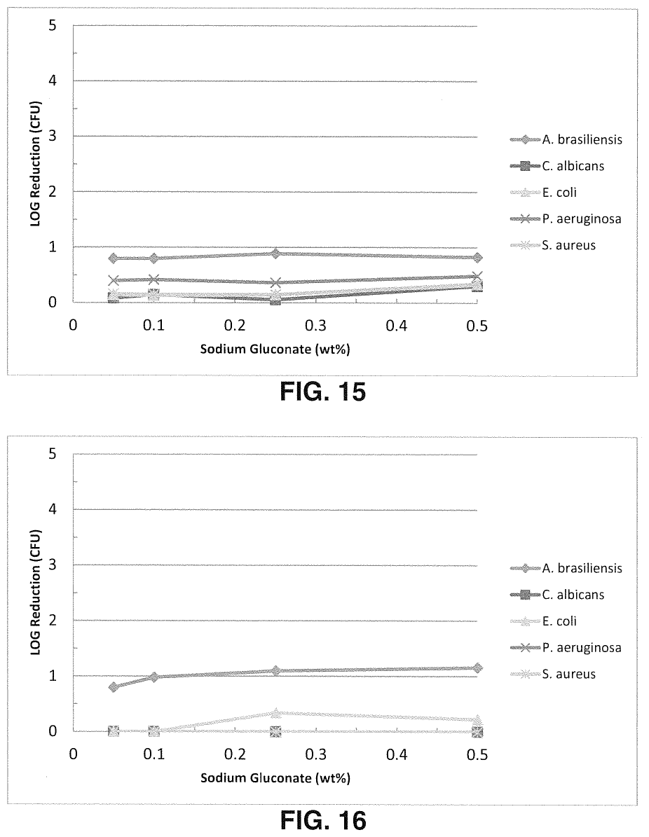

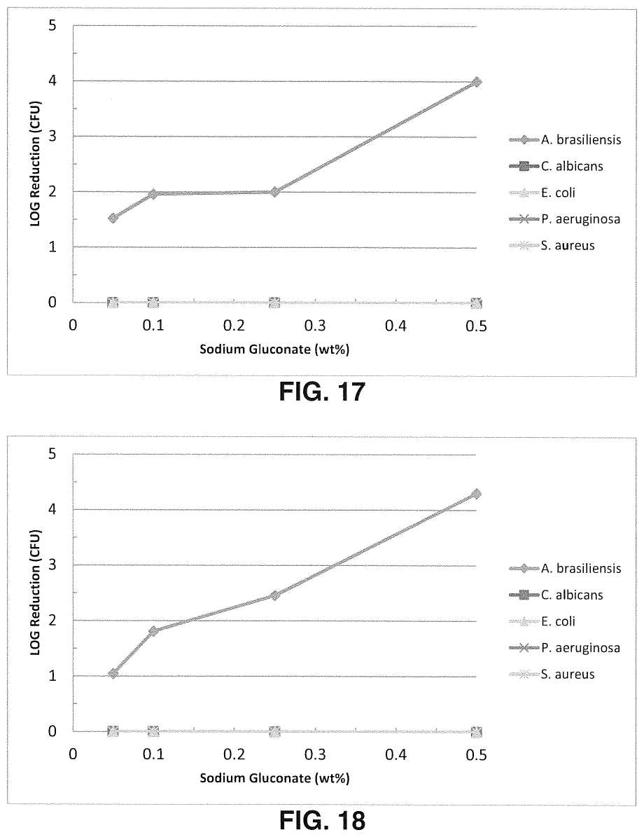

FIGS. 15 through 18 show the improved antimicrobial performance achieved by sodium gluconate in combination with sodium benzoate and benzyl alcohol. Particularly good activity was demonstrated against the mold A. brasiliensis at 14 and 28 days.

### Example 6—Tryptic Soy Broth Studies, pH 8, Caprylyl Glycol

The performance of various concentrations (at the same concentrations as Example 3) of caprylyl glycol in tryptic soy broth growth media was evaluated in combination with sodium benzoate and benzyl alcohol present in the same concentrations as in Example 4. Data was collected at 30 minutes and two days.

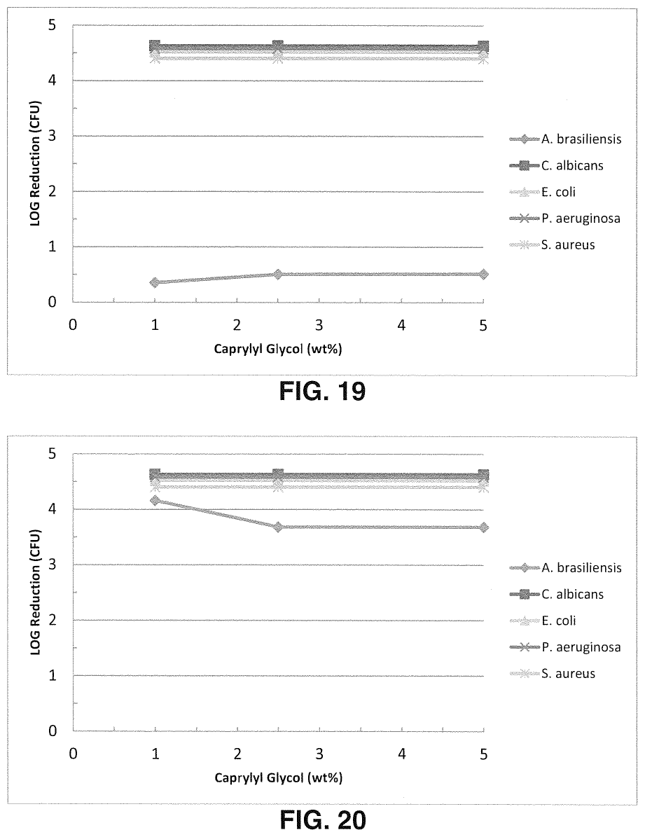

FIGS. 19 and 20 show improved antimicrobial performance achieved by caprylyl glycol in combination with low concentrations of sodium benzoate and benzyl alcohol in tryptic soy broth at pH 8. The results reflect a two-day, two-log reduction achieved against all microbes tested regardless of concentration of caprylyl glycol. The data also demonstrated versatility of caprylyl glycol against a wider pH range.

### Example 7—Skin Lotion Studies, 3-Phenyl Propanol

In this example, 3-phenyl propanol was used to enhance the performance of low concentrations of sodium benzoate and benzyl alcohol. This example evaluated boosting performance of 3-phenyl propanol in a skin lotion formulation having a pH of 6.5, the ingredients of which are listed in Table 1. Each formulation contained 0.25 wt. % of sodium benzoate and 0.25 wt. % of benzyl alcohol.

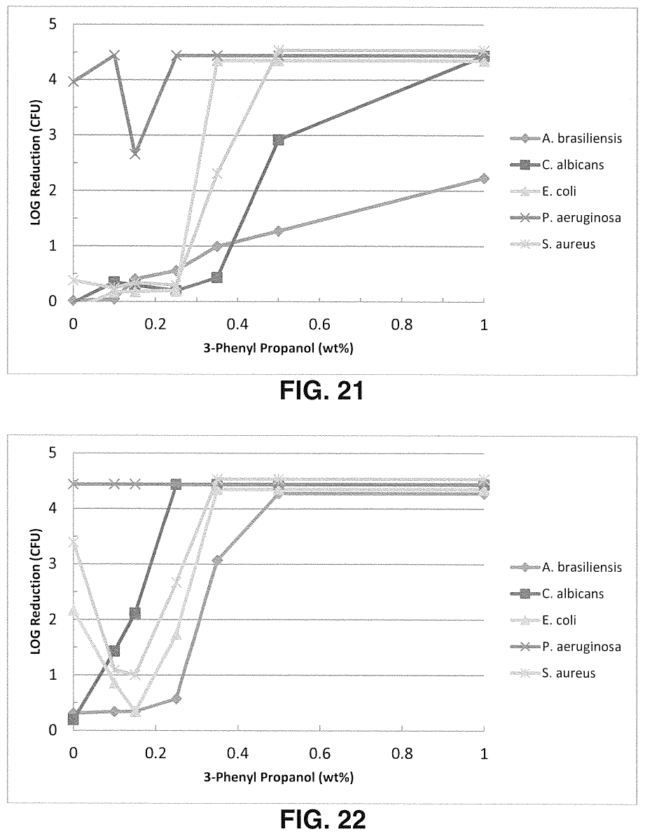

The log reduction of the microbes reflected in FIGS. 21 and 22 show that without the addition of 3-phenyl propanol, the formulations were not suitable to meet the challenging two-day, two-log reduction of P. aeruginosa and S. aureus outlined in the European Pharmacopeia method. In this example, 0.35 wt. % addition of 3-phenyl propanol enhanced the antimicrobial nature of the skin lotion to an extent that antimicrobial performance met the two-day and 14-day criteria set forth in the European Pharmacopeia summarized in the Challenge Testing Methodology section above.

### Example 8—Skin Lotion Studies, EDTA

In this example, EDTA was used to enhance the performance of sodium benzoate and benzyl alcohol in a skin lotion formulation at pH, the ingredients of which are set forth in Table 1. Each formulation contained 0.5 wt. % of sodium benzoate and 0.25 wt. % of EDTA with benzyl alcohol varying up to 1 wt. %. The control was comprised of 0.5 wt. % sodium benzoate and 1 wt. % benzyl alcohol without EDTA.

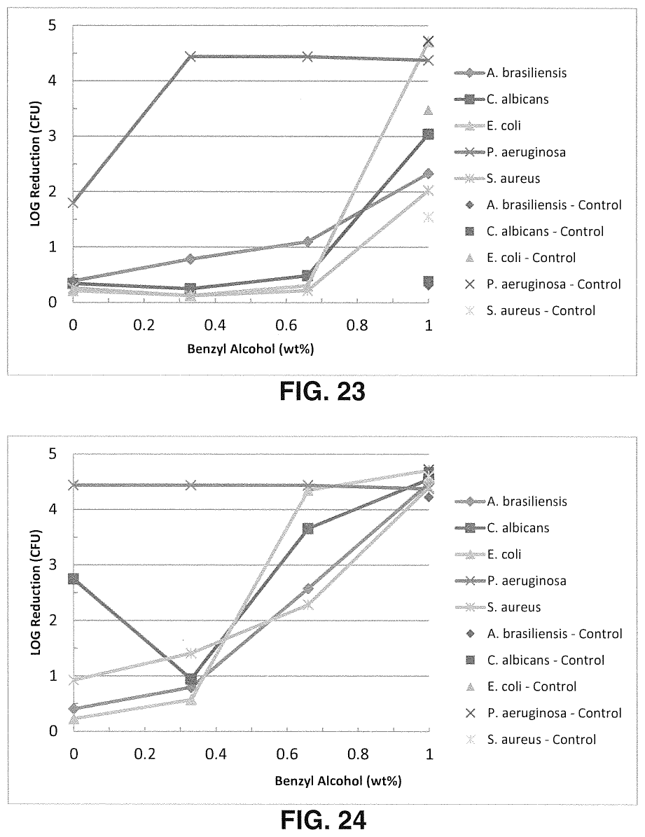

The log reduction of the microbes in FIGS. 23 and 24 show that without the addition of 0.25 wt. % EDTA, the skin lotion formulations comprising only sodium benzoate and benzyl alcohol were not suitable to meet the challenging two-day, two-log reduction of P. aeruginosa and S. aureus outlined in the European Pharmacopeia method (as summarized in the Challenge Testing Methodology section above) even at the higher use amounts of sodium benzoate and benzyl alcohol (0.5 wt. % and 1 wt. %, respectively). In this example, 0.25 wt. % addition of EDTA enhanced the antimicrobial nature of the formulation to an extent that antimicrobial performance met the two-day criteria set forth in the European Pharmacopeia with 0.5 wt. % sodium benzoate and 1 wt % benzyl alcohol. In this example, FIG. 24 shows that 0.25 wt. % addition of EDTA enhanced the antimicrobial nature of the formulation to an extent that antimicrobial performance met the 14-day criteria set forth in the European Pharmacopeia with concentrations of 0.5 wt. % sodium benzoate and 0.66 wt. % benzyl alcohol.

### Example 9—Skin Lotion Studies, Sodium Gluconate

In this example, sodium gluconate was used to enhance the performance of sodium benzoate and benzyl alcohol in a skin lotion formulation at pH 6.5, the ingredients of which are set forth in Table 1. Each formulation contained 0.5 wt. % of sodium benzoate and 0.25 wt. % of sodium gluconate, with benzyl alcohol varying up to 1 wt. %. The control comprised 0.5 wt. % sodium benzoate and 1 wt. % benzyl alcohol without sodium gluconate.

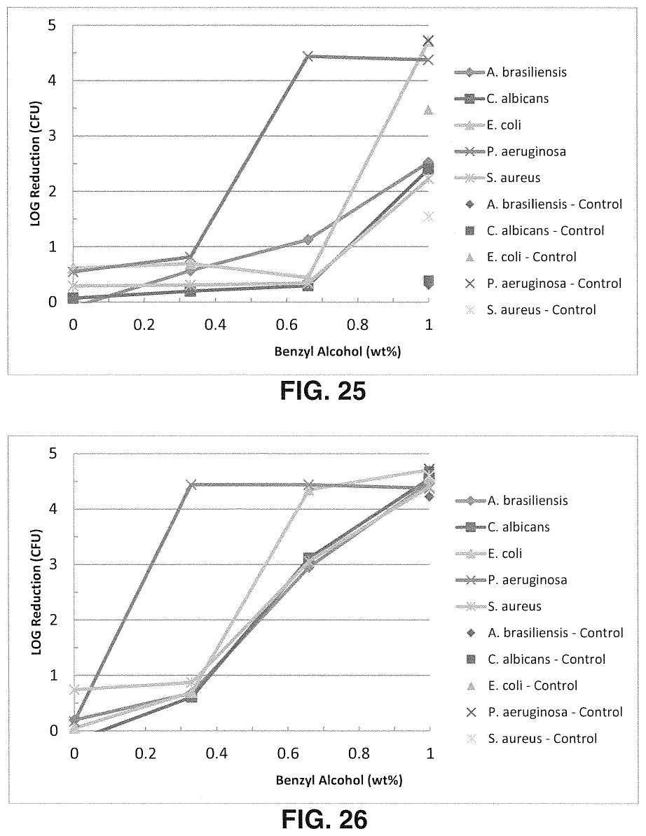

The log reduction of the microbes in FIGS. 25 and 26 show that without the addition of sodium gluconate, the formulations were not suitable to meet the challenging two-day, two-log reduction of P. aeruginosa and S. aureus outlined in the European Pharmacopeia method (summarized in the Challenge Testing Methodology section above) even at higher use levels of sodium benzoate and benzyl alcohol. In this example, 0.25 wt. % addition of sodium gluconate enhanced the antimicrobial nature of the formulation to an extent that antimicrobial performance met the two-day criteria set forth in the European Pharmacopeia with 0.5 wt. % sodium benzoate and 1 wt. % benzyl alcohol. In this example, FIG. 26 shows that the 0.25 wt. % addition of sodium gluconate enhanced the antimicrobial nature of the formulation to an extent that antimicrobial performance met the 14-day criteria set forth in the European Pharmacopeia with 0.5 wt. % sodium benzoate and 0.66 wt. % benzyl alcohol.

### Example 10—Skin Lotion Studies, Caprylyl Glycol

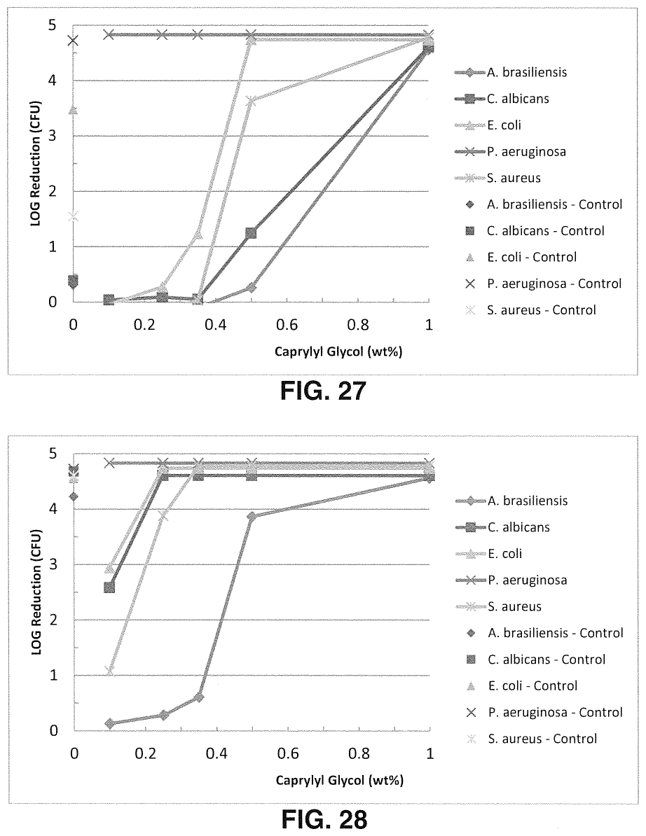

In this example, caprylyl glycol was used to enhance the performance of sodium benzoate and benzyl alcohol in a skin lotion formulation at pH 6.5, the ingredients of which are set forth in Table 1. FIGS. 27 and 28 reflect log reduction data of colony forming units (CFU) of microbe strains exposed to sodium benzoate, benzyl alcohol, and caprylyl glycol concentrations in skin lotion media after two and fourteen days. Each formulation had a fixed concentration 0.25 wt. % of sodium benzoate and 0.25 wt. % benzyl alcohol. A control was utilized comprising 0.5 wt. % sodium benzoate and 1 wt. % benzyl alcohol without caprylyl glycol.

The log reduction of the microbes in FIGS. 27 and 28 show that without the addition of caprylyl glycol, the formulations were not suitable to meet the challenging two-day, two-log reduction of P. aeruginosa and S. aureus outlined in the European Pharmacopeia method (as summarized in the Challenge Testing Methodology section above) even at higher use levels of sodium benzoate and benzyl alcohol. In this example, 0.5 wt. % addition of caprylyl glycol enhanced the antimicrobial nature of the formulation to an extent that antimicrobial performance met the two-day and 14-day criteria set forth in the European Pharmacopeia.

### Example 11 Tryptic Soy Broth Studies at pH 9.0

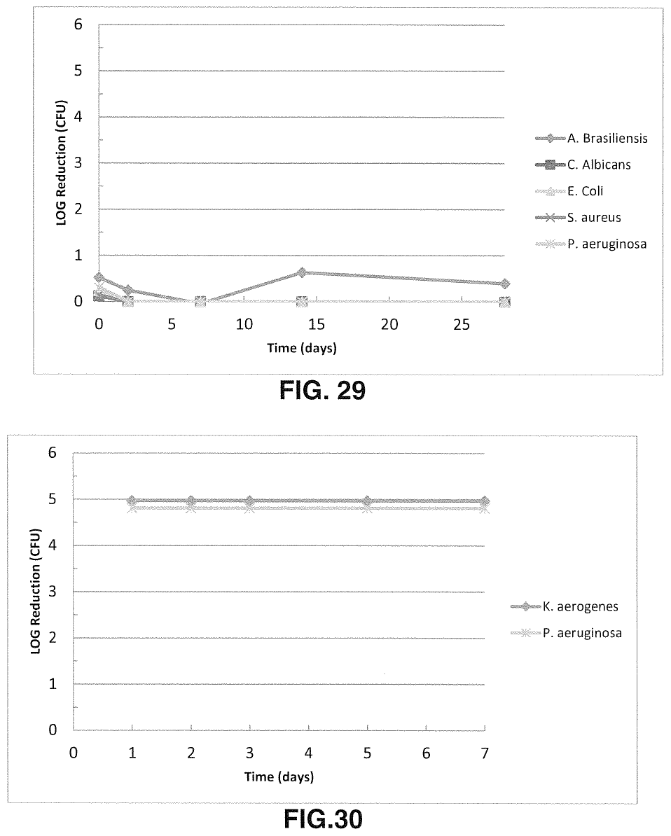

FIG. 30 shows antimicrobial effectiveness achieved by benzylamine alone at pH 9 in tryptic soy broth compared to a control (FIG. 29, no benzylamine). Strains of K. aerogenes (ATCC 13048) and P. aeruginosa (ATCC 9027) were utilized for testing as they are commonly found in many water-based products, including without limitation cosmetics and coatings. These organisms were challenged into the soy broth using the same methods as in the other examples. Time points were selected based on time points from ASTM 2574, which is a method for evaluating antimicrobial efficacy in waterborne emulsion based paints. Results for 2.5 wt. % benzyl alcohol (not shown) were exactly the same as for benzylamine.

The foregoing examples demonstrated boosted antimicrobial performance of sodium benzoate and benzyl alcohol when combined with a booster compound that is a chelating agent such as EDTA, sodium gluconate, an alcohol such as 3-phenyl propanol or a glycol such as caprylyl glycol. This enhanced performance was seen in tryptic soy broth studies, an excellent surrogate for evaluating performance in water-based or aqueous applications. The results demonstrated the capability for the inventive boosting technology in aqueous applications up to pH 8.0. Boosting capability was also demonstrated in a skin care formulation, achieving antimicrobial performance to meet stringent criteria with two-day, two-log reductions of bacteria at pH 6.5.

Additional non-limiting examples below describe use of the inventive boosters to improve antimicrobial efficacy of traditional preservatives used in specific end use applications and/or to reduce the amount of traditional preservatives required to achieve antimicrobial efficacy. Booster compounds of the invention achieve an improvement in antimicrobial efficacy of traditional preservatives against various microorganisms common to specific end use applications and at pH levels common to the applications, including without limitation in waterborne latex coatings at appropriate coatings pH levels and in a hair conditioner/shampoo. The booster compounds achieve improvement in antimicrobial efficacy even when used with traditional preservatives that are not organic acids or salts thereof or alcohols. Improved efficacy allows for a reduction in the amount of preservatives traditionally used or required to achieve antimicrobial effects.

### Example 12—Waterborne Coating/Paint

The following example is a waterborne coating with a polymer emulsion binder. The addition of benzylamine at levels ranging from 0.01 to 5 wt. %, along with traditional preservatives used in paint or coating formulations, produces improved antimicrobial efficacy and/or preservation as compared to that achieved with the use of the traditional preservatives alone, including without limitation benzoisothiazolinone, methylisothiazolinone, or methylchloroisothiazolinone. Improved efficacy may mean using less of the traditional preservatives. An exemplary waterborne coating formulation using benzylamine according to the invention is set forth below in Table 2.

TABLE 2
Waterborne Coating Formulation

| Component | Weight (lb) | Function |
|---|---|---|
| Grind | | |
| Water | 107 | Carrier |
| Tamol 851 | 10 | Dispersant |
| Byk 28 | 2 | Defoamer |
| Kronos TiO₂ | 487 | Pigment |
| Letdown | | |
| Water | 52 | Carrier |
| Raycryl 1207 | 330 | Polymer Emulsion Binder |
| Coalescent | 10 | Coalescent |
| Benzylamine | 10 | Antimicrobial |
| Preservative | Q.S. | Preservative |
| Natrosol HBR | 2 | Rheology Modifier |

### Example 13—Two-in-One Hair Conditioner/Shampoo

The following example is a two-in-one hair conditioner/shampoo, i.e., hair conditioning shampoo. The addition of sodium gluconate at the use level listed below, along with traditional preservatives sodium benzoate and benzyl alcohol, produces improved antimicrobial efficacy and/or preservation for the hair conditioner/shampoo formulation over that achieved with use of traditional preservatives alone. Improved efficacy may mean using less of the traditional preservatives.

TABLE 3
2 in 1 Hair Conditioner/Shampoo Formulation

| Component | Wt. % | Function |
|---|---|---|
| Deionized Water | Q.S. | Carrier |
| SLS | 7.0 | Surfactant |
| SLES-2 | 6.0 | Surfactant |
| Cocoamidopropyl betaine | 2 | Cosurfactant |
| Cocamide MEA | 2 | Cosurfactant |
| Polyquaternium 10 | 0.1 | Conditioning Polymer |
| NaCl | 1.5 | Rheology Modifier |
| Sodium Benzoate | 0.5 | Preservative |
| Benzyl Alcohol | 0.2 | Preservative |
| Sodium Gluconate | 0.25 | Antimicrobial |

While in accordance with the patent statutes the best mode and preferred embodiment have been set forth, the scope of the invention is not limited thereto, but rather by the scope of the attached claims.

1-23. (canceled)

24. An antimicrobial composition having enhanced or boosted antimicrobial activity against a wide range of microorganisms when used in an end use product, consisting of:
a booster compound for enhancing antimicrobial activity of an organic acid or salt thereof or an alcohol or mixtures thereof, present in amounts of 0.005 wt. % to 5 wt. %, in combination with:
a) an organic acid or salt thereof comprising benzoic acid, sorbic acid, citric acid, lactic acid, sodium citrate, propionic acid, sodium benzoate, potassium benzoate, potassium sorbate, sodium sorbate, or sodium lactate, or mixtures thereof, present in amounts of 0.005 wt. % to 10 wt. %; or
b) an alcohol comprising benzyl alcohol, 2,4 dichlorobenzyl alcohol, or benzyl ethanol, or mixtures thereof, present in amounts of 0.005 wt. % to 10 wt. %; or
c) a mixture of a and b,
wherein the booster compound is benzylamine, ethylenediaminetetraacetic acid or sodium salt thereof (EDTA), sodium gluconate, glutamic acid N,N-diacetic acid tetrasodium salt (GLDA-Na₄), or caprylyl glycol, or mixtures thereof,
wherein the booster compound provides synergistic and improved antimicrobial effects or preservation as compared to that achieved with an organic salt or acid thereof or alcohol alone or in combination,
wherein the antimicrobial compositions achieve a two-day or 14-day, two-log reduction of at least two organisms selected from the group consisting of Pseudomonas aeruginosa, Staphylococcus aureus, Aspergillus brasiliensis, Candida albicans, and Escherichia coli, and
wherein the wt. % are based upon the total weight of components of an end use product in which it is used.

25. The antimicrobial composition according to claim 24, wherein the organic acid (or salt thereof) comprises sodium benzoate, wherein the alcohol comprises benzyl alcohol, and wherein the booster compound comprises sodium gluconate.

26. The antimicrobial composition according to claim 24, wherein the organic acid or salt thereof comprises sodium benzoate, wherein the alcohol comprises benzyl alcohol, and wherein the booster compound comprises caprylyl glycol.

27. The antimicrobial composition according to claim 24, wherein the organic acid or salt thereof comprises sodium benzoate, wherein the alcohol comprises benzyl alcohol, and wherein the booster compound comprises ethylenediaminetetraacetic acid or sodium salt thereof.

28. The enhanced antimicrobial composition according to claim 24, wherein the organic acid or salt thereof comprises sodium benzoate, wherein the alcohol comprises benzyl alcohol, and wherein the booster compound comprises glutamic acid N,N-diacetic acid tetrasodium salt (GLDA-Na₄).

29. The antimicrobial composition according to claim 24, wherein the end use product comprises household products, laundry products, detergents, healthcare products, medical products, veterinary products, disinfectants, cosmetics, personal care products, skin lotions, industrial products, waterborne coatings, hair care products, paints, coatings, inks, lacquers, adhesives, sealants, caulks, plastisols, polymeric dispersions, polymeric emulsions, pharmaceutical compositions, or oil and gas recovery and drilling compositions.

30. The antimicrobial composition according to claim 24, wherein the booster compound is sodium gluconate, wherein the organic acid or salt thereof is sodium benzoate, wherein the alcohol is benzyl alcohol, and wherein the end-use product is a hair-conditioning shampoo.

31. The antimicrobial composition according to claim 24, wherein the booster compound is sodium gluconate, wherein the organic acid or salt thereof is sodium benzoate, wherein the alcohol is benzyl alcohol, and wherein the end-use product is a skin lotion.

32. The antimicrobial composition according to claim 24, wherein the booster compound is ethylenediaminetetraacetic acid or sodium salt thereof, wherein the organic acid or salt thereof is sodium benzoate, wherein the alcohol is benzyl alcohol, and wherein the end-use product is a skin lotion.

33. The antimicrobial composition according to claim 24, wherein the booster compound is caprylyl glycol, wherein the organic acid or salt thereof is sodium benzoate, wherein the alcohol is benzyl alcohol, and wherein the end-use product is a skin lotion.

34. A concentrated antimicrobial blend, consisting of:
a. a booster compound present in amounts of 0.01 wt. % to 90 wt. %, based on the total weight of the concentrated antimicrobial blend;
b. an organic acid or salt thereof comprising benzoic acid, citric acid, sorbic acid, lactic acid, sodium benzoate, potassium benzoate, potassium sorbate, sodium sorbate, or sodium lactate, or mixtures thereof;
c. an alcohol comprising benzyl alcohol, 2,4 dichlorobenzyl alcohol, or benzyl ethanol, or mixtures thereof,
wherein the organic acid or salt thereof and non-booster alcohol are added in amounts sufficient so that the amounts of all of the components total 100 wt. %, based on the total weight of the concentrated antimicrobial blend, and
wherein the booster compound is benzylamine, ethylenediaminetetraacetic acid or sodium salt thereof (EDTA), sodium gluconate, glutamic acid N,N-diacetic acid tetrasodium salt (GLDA-Na₄), or caprylyl glycol, or mixtures thereof.

35. The concentrated antimicrobial blend according to claim 34, further diluted with a solvent.

36. The concentrated antimicrobial blend of claim 35, wherein the solvent is water, isopropyl alcohol, propylene glycol, dipropylene glycol, diethylene glycol dibenzoate, dipropylene glycol dibenzoate, propylene glycol dibenzoate, 3-phenyl propyl benzoate, acetone, ethyl acetate, n-butyl acetate, propylene glycol n-butyl ether, dipropylene glycol n-butyl ether, diethylene glycol monomethyl ether, diethylene glycol monoethyl ether, dipropylene glycol dimethyl ether, xylene, toluene, tetrahydrofuran, chloroform, methyl ethyl ketone, cyclohexane or mixtures thereof.

37. A booster compound for improving the antimicrobial efficacy of preservatives in waterborne coatings or paints, consisting of benzylamine present in amounts ranging from 0.01 wt. % to 5 wt. %, based on the total weight of the waterborne coating or paint,

38. A method of boosting the antimicrobial efficacy of an antimicrobial or preservative composition comprising an organic acid or salt thereof or an alcohol, or mixtures thereof, comprising the step of:
adding a boosting compound to the antimicrobial composition, wherein the booster compound comprises benzylamine, ethylenediaminetetraacetic acid or sodium salt thereof (EDTA), sodium gluconate, glutamic acid N,N-diacetic acid tetrasodium salt (GLDA-Na₄), or caprylyl glycol, or mixtures thereof,
wherein the organic acid or salt thereof comprises benzoic acid, sorbic acid, citric acid, lactic acid, sodium citrate, propionic acid, sodium benzoate, potassium benzoate, potassium sorbate, sodium sorbate, or sodium lactate, or mixtures thereof, and
wherein the alcohol comprises benzyl alcohol, 2,4 dichlorobenzyl alcohol, or benzyl ethanol, or mixtures thereof.
